(19) United States
(12) Patent Application Publication
(10) Pub. No.: US 2014/0218355 A1
(43) Pub. Date: Aug. 7, 2014

(54) MAPPING CONTENT DIRECTLY TO A 3D GEOMETRIC PLAYBACK SURFACE

(71) Applicant: Condition One, Inc., Mill Valley, CA (US)

(72) Inventors: Peter Wilkins, Novato, CA (US); Christopher Ryan Wheeler, San Jose, CA (US); Jay Brown, Belmont, CA (US); Barton Wells, Palo Alto, CA (US)

(21) Appl. No.: 14/150,719

(22) Filed: Jan. 8, 2014

Related U.S. Application Data
(60) Provisional application No. 61/749,956, filed on Jan. 8, 2013.

(51) Int. Cl. G09G 5/391; G06T 15/10; G06T 7/00

(52) U.S. Cl. CPC G09G 5/391; G06T 7/0081; G06T 15/10
USPC 345/419

(57) ABSTRACT

Systems and methods for mapping content directly to a 3D geometric playback surface. A source file is generated that includes content in a native format. A 3D geometric playback surface to which content can be mapped is generated. A portion of the 3D geometric playback surface to map content to is determined. The content is mapped to a determined portion of a 3D geometric playback surface in a native format of the content. Content mapped to a portion of a 3D geometric playback surface in a native format of the content is played from the 3D geometric playback surface.

### CROSS-REFERENCE TO RELATED APPLICATION

This application claims priority to U.S. Provisional Ser. No. 61/749,956, filed Jan. 8, 2013, entitled “Mapping Video Frames Directly to a 3-D Surface,” which is incorporated herein by reference.

### BACKGROUND

An area of ongoing research and development is displaying content to users. A particular area of interest is displaying content to users in a format that creates a virtual reality environment for the user, such that a user feels like they are at the location where the content was captured.

In creating a virtual reality environment, problems have arisen with displaying content to a user in a manner to create an immersive experience where the user actually fells as if they are in the environment. In particular, problems have arisen with mapping content for playback and display to a user in creating a virtual reality environment.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Various implementations include systems and methods for mapping content directly to a 3D geometric playback surface. In a specific implementation, a source file is generated that includes content in a native format. Further in the specific implementation, a 3D geometric playback surface to which content can be mapped is generated. A portion of the 3D geometric playback surface to map content to is determined. In the specific implementation, content is mapped to a determined portion of a 3D geometric playback surface in a native format of the content. Also in the specific implementation, content mapped to a portion of a 3D geometric playback surface in a native format of the content is played from the 3D geometric playback surface.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for rendering captured data by mapping the captured data to a 3D geometric playback surface.

FIG. 2 depicts a diagram of an example of a system for capturing and mapping content to a 3D geometric playback surface.

FIG. 3 depicts a diagram of an example of a system for generating a 3D geometric playback surface.

FIG. 4 depicts a diagram of an example of a system for mapping content to a 3D geometric playback surface.

FIG. 5 depicts a flowchart of an example of a method for mapping content to a 3D geometric playback surface.

FIG. 6 depicts a flowchart of an example of a method for mapping content to a 3D geometric playback surface with playback surface subdivisions.

FIG. 7 depicts a flowchart of an example of a method for dividing a source file that contains content based on resolution and mapping the content to a 3D geometric playback surface.

### DETAILED DESCRIPTION

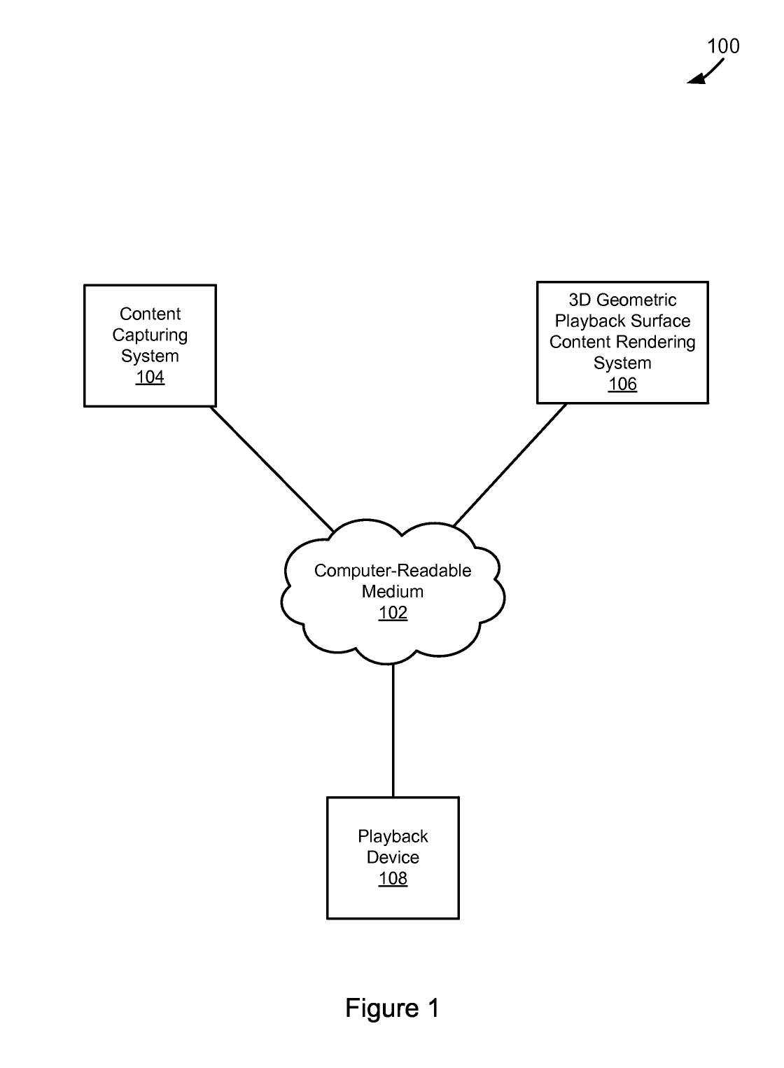

FIG. 1 depicts a diagram 100 of an example of a system for rendering captured data by mapping the captured data to a 3D geometric playback surface. The system of the example of FIG. 1 includes a computer-readable medium 102, a content capturing system 104, a 3D geometric playback surface content rendering system 106, and a playback device 108.

The content capturing system 104, the 3D geometric playback surface content rendering system 106, and the playback device 108 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the content capturing system 104, the 3D geometric playback surface content rendering system 106, the client device and applicable other systems, or devices described in this paper can be implemented as a computer system or parts of a computer system or a plurality of computer systems. A computer system, as used in this paper, can include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can be a specific purpose engine that includes specific purpose hardware, firmware, or software embodied in a computer-readable medium for execution by the processor. The processor transforms data into new data using implemented data structures and methods, such as is described with reference to the FIGs. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the content capturing system 104 functions to capture content. In capturing content, the content capturing system 104 can generate source files that include the content captured by the content capturing system 104. Content captured by the content capturing system 104, can include images. Depending upon implementation-specific or other considerations, images captured by the content capturing system 104 can be stills or part of a video. Content captured by the content capturing system 104 can include playback content that can be played back or displayed to a user of a device, such as the playback device 108. Further, content captured by the content capturing system 104 can be digital content that is either or both captured and represented as digital content and stored as digital content.

In a specific implementation, the content capturing system 104 functions to capture content by detecting electromagnetic radiation, and creating a digital or analog representation of differences in wavelengths of electromagnetic radiation within a capture region. The representation of differences in wavelengths of electromagnetic radiation within a capture region can serve as the basis for images, either still or part of a video, that form the content captured by the content capturing system 104. Depending upon implementation-specific or other considerations, electromagnetic radiation that is captured by the content capturing system 104 includes visible light. Specifically, the content capturing system 104 can be implemented as a camera or a video recorder that detects differences in wavelengths of electromagnetic radiation that is captured within a capture region and creating a digital or analog representation of the differences. In being implemented as a camera or a video recorder, the content capturing system 104 can be an applicable system for detecting and creating a representation of differences in wavelengths of electromagnetic radiation captured within a capture region. For example, the content capturing system 104 can be a single-lens reflex (hereinafter referred to as “SLR”) camera, or a viewfinder camera. Additionally, the content capturing system 104 can use an applicable lens of an applicable size or level in detecting and creating a representation of differences in wavelengths of electromagnetic radiation captured within a capture region. For example, the content capturing system 104 can include a hemispherical lens at varying levels for detecting electromagnetic radiation.

In a specific implementation, the content capturing system 104 functions to capture other stimuli that can be perceived by a user to whom captured content is played back. Depending upon implementation-specific or other considerations, the content capturing system 104 can capture sounds. Specifically, the content capturing system 104 can include a recording device that detects sounds and creates a digital or analog representation of the detected sounds in capturing content. In various other examples, the content capturing system 104 can capture other stimuli that can be perceived by a user as if the user was at the location at which the content capturing system 104 captures the content. For example, the content capturing system 104 can capture stimuli such as temperature, vibration, wind speed, or the like. Specifically, the content capturing system 104 can include applicable sensors for capturing stimuli such as temperature, vibration, wind speed, or the like.

In a specific implementation, the 3D geometric playback surface content rendering system 106 functions to generate a 3D geometric playback surface upon which content can be mapped to and played back from to a user. Depending upon implementation-specific or other considerations, a 3D geometric playback surface can be of an applicable shape or size upon which content can be mapped to and played from to a user. For example, a 3D geometric playback surface generated by the 3D geometric playback surface content rendering system 106 can be a hemisphere, of which content is mapped to the concave portion of the hemisphere. In generating a 3D geometric playback surface, the 3D geometric playback surface content rendering system 106 can generate a base geometry that is used to generate the 3D geometric playback surface. The 3D geometric playback surface content rendering system 106 can use a generated based geometry to generate an intermediary geometry using applicable techniques, such as linear subdivision. Further, the 3D geometric playback surface content rendering system 106 can create a single mapping geometry that does not include any subdivisions, from the intermediary geometry. After generating an intermediary geometry, the 3D geometric playback surface content rendering system 106 can divide the single mapping geometry into a plurality of subdivisions to create a 3D geometric playback surface with a plurality of playback surface subdivisions. Alternatively, the 3D geometric playback surface content rendering system 106 can leave the single mapping geometry un-subdivided and create a 3D geometric playback surface from the single mapping geometry that does not include playback surface subdivisions.

In a specific implementation, the 3D geometric playback surface content rendering system 106 functions to map content to a 3D geometric playback surface, thereby at least in part rendering the content. Depending upon implementation-specific or other considerations, the 3D geometric playback surface content rendering system 106 can map content captured by the content capturing system 104 to a 3D geometric playback surface directly from the content capturing system 104. Further depending upon implementation-specific or other considerations, the 3D geometric playback surface content rendering system 106 can map content captured by the content capturing system 104 directly to a 3D geometric playback surface as the content is captured by the content capturing system 104. In mapping content that is captured by the content capturing system 104 to a 3D geometric playback surface, the 3D geometric playback surface content rendering system 106 can map the content in the native format in which the content was captured to the 3D geometric playback surface. Specifically, the 3D geometric playback surface content rendering system 106 can map content to a 3D geometric playback surface without processing captured content into a rectilinear format before mapping the content to a 3D geometric playback surface. For example, if content is captured and created in the advanced systems format (hereinafter referred to as “asf”), then the 3D geometric playback surface content rendering system 106 can map the content to a 3D geometric playback surface as asf data.

In a specific implementation, the 3D geometric playback surface content rendering system 106 maps content to playback surface subdivisions within a 3D geometric playback surface. Depending upon implementation-specific or other considerations, the 3D geometric playback surface content rendering system 106 can associate a source file of content to a playback surface subdivision within a 3D geometric playback surface so that the source file of content is only mapped to the playback surface subdivision within the 3D geometric playback surface of which it is associated. A source file associated with a playback surface subdivision can be a single source file containing content or a subdivided source file that is created from a source file. Additionally, the 3D geometric playback surface content rendering system 106 can associate and map a plurality of source files including content to playback surface subdivisions within a 3D geometric playback surface simultaneously, to aggregate content contained within the plurality of source files. The 3D geometric playback surface content rendering system 106 can map a plurality of source files that include content captured from the content capturing system 104 directly from the content capturing system 104 to a 3D geometric playback surface in the native source file format of the source files created by the content capturing system 104. Additionally, the 3D geometric playback surface content rendering system 106 can associate and map a plurality of source files to playback surface subdivisions within a 3D geometric playback surface directly from the content capturing system in the native format of a plurality of source files simultaneously, to aggregate content contained in the plurality of source files.

In a specific implementation, the 3D geometric playback surface content rendering system 106 functions to control or include a plurality of content players to control playback of content that is mapped to a 3D geometric playback surface. Depending upon implementation-specific or other considerations, the 3D geometric playback surface content rendering system 106 can include or control content players that play content mapped to a playback surface subdivision of a 3D geometric playback surface. Further depending upon implementation-specific or other considerations, content players included as part of or controlled by the 3D geometric playback surface content rendering system 106 can be uniquely associated with a single playback surface subdivision within a 3D geometric playback surface. In uniquely associated a content player with a single playback surface subdivision within a 3D geometric playback surface, a single content player uniquely associated with a playback surface subdivision can singularly play content that is mapped to the playback surface subdivision that the content player is associated.

In a specific implementation, the 3D geometric playback surface content rendering system 106 maps content to a 3D geometric playback surface at a render rate independently of a playback rate of content players that play content mapped to the 3D geometric playback surface. The 3D geometric playback surface content rendering system 106 can map content to a 3D geometric playback surface at a rate that is greater than a playback rate of content players that play content mapped to the 3D geometric playback surface. For example, the 3D geometric playback surface content rendering system 106 can map content to a 3D geometric playback surface at a render rate of up to 60 frames per second, even if the content players play content mapped to the 3D geometric playback surface at a rate of 24 to 30 frames per second.

In a specific implementation, the 3D geometric playback surface content rendering system 106 can function to place and move a virtual sensor within a 3D geometric playback surface to which content is mapped. A virtual sensor placed and move by the 3D geometric playback surface content rendering system 106 can be used to indicate what portion of content mapped to a 3D geometric playback surface to display to a user. For example, if a virtual sensor is placed at a center of mapped content, then all content within a 100 pixel square that is centered by the virtual sensor can be displayed to a user. The 3D geometric playback surface content rendering system 106 can place and move a virtual sensor within a 3D geometric playback surface based on received input. Depending upon-implementation specific or other considerations, the 3D geometric playback surface content rendering system 106 can place and move a virtual sensor within a 3D geometric playback surface based on input received form a playback device. For example, a playback device can include sensors (such as accelerometers and gyroscopes) for detecting the movement of a user using the playback device and input from the playback device can reflect the movement of a user. Further in the example, if a user tilts their head to the left to view content on a 3D geometric playback surface that is outside of the displayed portion of content, as indicated by a virtual sensor, then the 3D geometric playback surface content rendering system 106 can move the virtual sensor according to the input so that the user can view a new portion of content that a user would see if they were in the environment in which the content was captured and tilted their head to the left.

In a specific implementation, the 3D geometric playback surface content rendering system 106 functions to determine if a resolution of content to be mapped to a 3D geometric surface is too high to playback in its native format on a playback device. Depending upon-implementation specific or other considerations, if the 3D geometric playback surface content rendering system 106 determines that the resolution of content is too high to be played back on a playback device, then the 3D geometric playback surface content rendering system 106 can divide a source file that includes the content into subdivided source files that include a portion of the content and are of a lower resolution than the source file that contains the content. Further depending upon-implementation specific or other considerations, the 3D geometric playback surface content rendering system 106 can divide a source file into subdivided source files so that the subdivided source files include portions of content in the native format of the content included in the source file. After dividing a source file into subdivided source files, the 3D geometric playback surface content rendering system 106 can map the content in the subdivided source files to the 3D geometric playback surface so that the content contained within the subdivided source files is aggregated on the 3D geometric playback surface to represent content that was included in an original source file from which the subdivided source files is created. In various implementations, the 3D geometric playback surface content rendering system 106 can map a subdivided source file to a specific subdivision within the 3D geometric playback surface that is uniquely associated with the specific subdivided source file that is mapped to it.

In a specific implementation, the playback device 108 functions according to an applicable device for playing or displaying content that is mapped to a 3D geometric playback surface. The playback device 108 includes a display for displaying content that is mapped to a 3D geometric playback surface. Depending upon implementation-specific or other considerations, the playback device 108 can include content players that are controlled by the 3D geometric playback surface content rendering system 106 and used to play content that is displayed on a display that is included as part of the playback device 108. Further depending upon implementation-specific or other considerations, the playback device 108 can include sensors that are used to generate input that is used by the 3D geometric playback surface content rendering system 106 to control placement and movement of a virtual sensor in a 3D geometric playback surface. For example, the playback device 108 can include sensors to detect the movement of a user of the playback device to generate input regarding the movement of the user.

In an example of operation of the example system shown in FIG. 1, the content capturing system 104 functions to capture content that is playback content for playing or display to a user of a playback device. Further in the example of operation of the example system shown in FIG. 1, the 3D geometric playback surface content rendering system 106 functions to map content captured by the content capturing system 104 to a 3D geometric playback surface in the native format in which the content was captured by the content capturing system 104. In the example of operations, the playback device 108 functions to play and/or display content that is captured by the content capturing system 104 and mapped to a 3D geometric playback surface by the 3D geometric playback surface content rendering system 106.

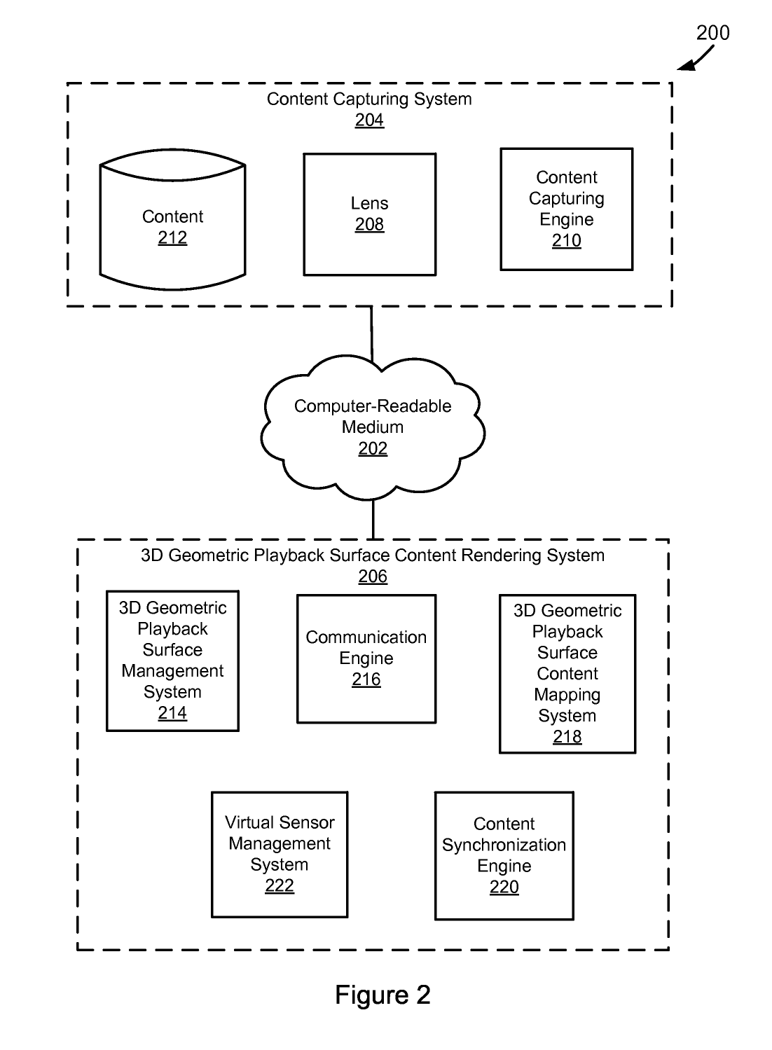

FIG. 2 depicts a diagram 200 of an example of a system for capturing and mapping content to a 3D geometric playback surface. The system shown in FIG. 2 includes a computer-readable medium 202, a content capturing system 204 and a 3D geometric playback surface content rendering system 206. The content capturing system 204 and the 3D geometric playback surface content rendering system 206 are coupled to each other through the computer-readable medium 202.

In a specific implementation, the content capturing system 204 functions according to an applicable system for capturing content, such as the content capturing systems described in this paper. The content capturing system 204 in the example system shown in FIG. 2 includes a lens 208, a content capturing engine 210 and a content datastore 212.

In a specific implementation, the lens 208 functions according to an applicable system for transmitting and refracting electromagnetic radiation for capturing of content. Specifically, depending upon implementation-specific or other considerations, the lens 208 can refract light to a content capturing engine 210 that functions to create content based on differences in wavelengths or intensity of electromagnetic radiation refracted by the lens 208. Further depending upon implementation-specific or other considerations, the lens 208 can be an applicable lens for refracting electromagnetic radiation to systems or engine within the content capturing system 204. In one example, the lens 208 is a hemispheric lens. In further examples the lens 208 is a hemispheric lens. The lens 208 can be of various lens levels. Still in further examples, the lens 208 is an applicable lens that is capable of refracting electromagnetic radiation.

In a specific implementation, the content capturing engine 210 include applicable systems or devices that are capable of detecting and recording electromagnetic radiation that is refracted by the lens 208 to create content. The content created by the content capturing engine can be created and/or stored as source files. Depending upon implementation-specific or other considerations the content capturing engine 210 includes an image sensor for detecting and recording electromagnetic radiation, including electromagnetic radiation at various wavelengths. In one example, the content capturing engine 210 includes a charge-coupled device that includes active pixel sensors. The content capturing engine 210 can generate an image based on difference in the wavelength of electromagnetic radiation that is refracted by the lens 208 to the content capturing engine 210.

In a specific implementation, the content capturing engine 210 can include or be coupled to sensors for capturing various stimuli that can be perceived by a user using a playback device. The various stimuli captured by the content capturing engine 210 can form part of content and be generated and/or stored as source files. For example, the content capturing engine 210 can include or be coupled to applicable sensors for measuring sound, temperature, vibration, wind speed, or the like. The content capturing engine 210 can generate content based on measurements made by applicable sensors of perceivable stimuli, such as the previously discussed stimuli. For example, the content capturing engine 210 can generate content that includes a sound recording.

In a specific implementation, the content datastore 212 functions to store content that is generated by the content capturing engine 210 based on electromagnetic radiation that is refracted by the lens 208 to the content capturing engine 21. Further depending upon implementation-specific or other considerations, the content datastore 212 functions to store content that is generated by the content capturing engine 210 based on measurements of applicable sensors of perceivable stimuli. In various implementations, the content datastore 212 stores images along with sound captured while the images were captured. Content stored in the content datastore 212 can be stored in the native format in which the content was generated. For example, content stored in the content datastore 212 can be stored as asf data.

In a specific implementation, the 3D geometric playback surface content rendering system 206 functions according to an applicable system for mapping content to a 3D geometric playback surface, such as the 3D geometric playback surface content rendering systems described in this paper. In the example system shown in FIG. 2, the 3D geometric playback surface content rendering system 206 includes a 3D geometric playback surface management system 214, a communication engine 216, a 3D geometric playback surface content mapping system 218, a content synchronization engine 220, a virtual sensor management system 222.

In a specific implementation, the 3D geometric playback surface management system 214 functions to generate 3D geometric playback surfaces to which content can be mapped and played back to a user. Depending upon implementation-specific or other considerations, a 3D geometric playback surface can be of an applicable shape or size upon which content can be mapped to and played from to a user. For example, a 3D geometric playback surface generated by the 3D geometric playback surface management system 214 can be a hemisphere, of which content is mapped to the concave portion of the hemisphere. In generating a 3D geometric playback surface, the 3D geometric playback surface management system 214 can generate a base geometry that is used to generate the 3D geometric playback surface. The 3D geometric playback surface management system 214 can use a generated based geometry to generate an intermediary geometry using applicable techniques, such as linear subdivision. Further, the 3D geometric playback surface management system 214 can create a single mapping geometry, which only includes one subdivision, from the intermediary geometry. After generating an intermediary geometry, the 3D geometric playback surface management system 214 can divide the single mapping geometry into a plurality of subdivisions to create a 3D geometric playback surface with a plurality of playback surface subdivisions. Further depending upon-implementation specific or other considerations, the 3D geometric playback surface management system 214 can generate a 3D geometric playback surface based on the shape of content captured by the content capturing system 204 and/or characteristics of a playback device upon which the content that is mapped to the 3D geometric playback surface will be played back from or displayed through. For example, if content is captured in a hemisphere view, then the 3D geometric playback surface management system 214 can generate a 3D geometric playback surface that is a hemisphere. In another example, if content is captured in a cylindrical view around a central point, then the 3D geometric playback surface management system 214 can generate a 3D geometric playback surface that is a cylinder.

In a specific implementation, the communication engine 216 functions to receive data. The communication engine 216 can receive data from the content capturing system 204. For example, the communication engine 216 can receive content that is either or both generated by the content capturing engine 210 and stored in the content datastore 212. Depending upon implementation-specific or other considerations, the communication engine 216 can receive content as it is generated by the content capturing engine 210. The communication engine 216 can also receive data from a playback device or an applicable device associated with a user. Data received by the communication engine 216 or an applicable device associated with a user can include input, including requests to view content or input used to place and control movement of a virtual sensor within a 3D geometric playback surface. For example, the communication engine 216 can receive input regarding movement of a playback device or a user using the playback device.

In a specific implementation, the 3D geometric playback surface content mapping system 218 functions to map content to a 3D geometric playback surface. The 3D geometric playback surface content mapping system 218 can map content captured by the content capturing system 204 to a 3D geometric playback surface directly from the content capturing system 204. Depending upon implementation-specific or other considerations, the 3D geometric playback surface content mapping system 218 can map content captured by the content capturing system 204 directly to a 3D geometric playback surface as the content is captured by the content capturing system 204. In mapping content that is captured by the content capturing system 204 to a 3D geometric playback surface, the 3D geometric playback surface content mapping system 218 can map the content in the native format in which the content was captured to the 3D geometric playback surface. Specifically, the 3D geometric playback surface content mapping system 218 can map content to a 3D geometric playback surface without processing captured content into a rectilinear format before mapping the content to a 3D geometric playback surface. For example, if content is captured and created as asf data, then the 3D geometric playback surface content mapping system 218 can map the content to a 3D geometric playback surface as asf data.

In a specific implementation, the 3D geometric playback surface content mapping system 218 maps content to playback surface subdivisions within a 3D geometric playback surface. Depending upon implementation-specific or other considerations, the 3D geometric playback surface content mapping system 218 can associate a source file of content to a playback surface subdivision within a 3D geometric playback surface so that the source file of content is only mapped to the playback surface subdivision within the 3D geometric playback surface of which it is associated. Additionally, the 3D geometric playback surface content mapping system 218 can associate and map a plurality of source files or subdivisions of source files including content to playback surface subdivisions within a 3D geometric playback surface simultaneously, thereby allowing content contained within the plurality of source files or subdivisions of source files to be aggregated when mapped to the 3D geometric playback surface. The 3D geometric playback surface content mapping system 218 can map a plurality of source files that include content captured from the content capturing system 204 directly from the content capturing system 204 to a 3D geometric playback surface in the native source file format of the source files created by the content capturing system 204. Additionally, the 3D geometric playback surface content mapping system 218 can associate and map a plurality of source files to playback surface subdivisions within a 3D geometric playback surface directly from the content capturing system in the native format of a plurality of source files simultaneously, to aggregate content contained in the plurality of source files.

In a specific implementation, the 3D geometric playback surface content mapping system 218 maps content to a 3D geometric playback surface at a render rate independently of a playback rate of content players that play content mapped to the 3D geometric playback surface. The 3D geometric playback surface content mapping system 218 can map content to a 3D geometric playback surface at a rate that is greater than a playback rate of content players that play content mapped to the 3D geometric playback surface. For example, the 3D geometric playback surface content mapping system 218 can map content to a 3D geometric playback surface at a render rate of up to 60 frames per second, even if content players play content mapped to the 3D geometric playback surface at a rate of 24 to 30 frames per second.

In a specific implementation, the 3D geometric playback surface content mapping system 218 functions to determine if a resolution of content to be mapped to a 3D geometric surface is too high to playback in its native format on a playback device. Depending upon-implementation specific or other considerations, if the 3D geometric playback surface content mapping system 218 determines that the resolution of content is too high to be played back on a playback device, then the 3D geometric playback surface content mapping system 218 can divide a source file that includes the content into subdivided source files that include a portion of the content and are of a lower resolution than the source file that contains the content. Further depending upon-implementation specific or other considerations, the 3D geometric playback surface content mapping system 218 can divide a source file into subdivided source files so that the subdivided source files include portions of content in the native format of the content included in the source file. After dividing a source file into subdivided source files, the 3D geometric playback surface content mapping system 218 can map the content in the subdivided source files to the 3D geometric playback surface so that the content contained within the subdivided source files is aggregated on the 3D geometric playback surface to represent content that was included in an original source file from which the subdivided source files is created. In various implementations, the 3D geometric playback surface content mapping system 218 can map a subdivided source file to a specific subdivision within the 3D geometric playback surface, which is uniquely associated with the specific subdivided source file that is mapped to it.

In a specific implementation, the content synchronization engine 220 functions to control content players that play content mapped to a 3D geometric playback surface by the 3D geometric playback surface content mapping system 218. Depending upon implementation-specific or other considerations, the content synchronization engine 220 controls players that are integrated as part of the 3D geometric playback surface content rendering system 206 or a playback device through which played content is displayed to a user. Further depending upon implementation-specific or other considerations, the content synchronization engine 220 can control content players that are uniquely associated to playback surface subdivisions, so that each content player plays content that is mapped to a playback surface subdivision that the content player is uniquely associated. For example, if content A is mapped to playback surface subdivision A that is uniquely associated with content player A, then the content synchronization engine can control content player A to play content A. In controlling content players, the content synchronization engine 220 can synchronize the content players such that content that is mapped to a plurality of playback surface subdivisions is aggregated on the 3D geometric playback surface when mapped to playback surface subdivisions of the 3D geometric playback surface.

In a specific implementation, the virtual management engine functions to place and move a virtual sensor within a 3D geometric playback surface. A virtual sensor placed and move in a 3D geometric playback surface by the virtual sensor management system 222 can be used to indicate what portion of content that is mapped to a 3D geometric playback surface to display to a user. In one example, if a virtual sensor is placed at a center of mapped content, then all content within a 100 pixel square that is centered by the virtual sensor can be displayed to a user. The virtual sensor management system can place and move a virtual sensor within a 3D geometric playback surface based on received input. Depending upon-implementation specific or other considerations, the virtual sensor management system 222 can place and move a virtual sensor within a 3D geometric playback surface based on input received form a playback device. For example, a playback device can include sensors (such as accelerometers and gyroscopes) for detecting the movement of a user using the playback device and input from the playback device can reflect the movement of a user. Further in the example, if a user tilts their head to the left to view content on a 3D geometric playback surface that is outside of the displayed portion of content, as indicated by a virtual sensor, then the virtual sensor management system 222 can move the virtual sensor according to the input so that the user can view a new portion of content that a user would see if they were in the environment in which the content was captured and tilted their head to the left. Further depending upon-implementation specific or other considerations, the virtual sensor management system 222 can move a virtual sensor within a 3D geometric playback surface based on a position of a horizon line within displayed content as indicated by the virtual sensor. For example, the virtual sensor management system 222 can move a virtual sensor within a 3D geometric playback surface so that a horizon line in displayed content remains centered in the displayed content.

In a specific implementation, the virtual sensor management system 222 can dynamically change the size of a window of displayed content that is indicated by a virtual sensor placed in a 3D geometric playback surface. For example, the virtual sensor management system 222 can change a size of a window of displayed content from a 1000 by 1000 pixel window centered about a central pixel to an 800 by 800 pixel window centered about the central pixel. Depending upon implementation-specific or other considerations, the virtual sensor management system 222 dynamically changes the size of a window of displayed content that is indicated by a virtual sensor in order to center a horizon line across the content that is displayed in the window of displayed content.

In an example of operation of the example system shown in FIG. 2, the content capturing system 204 functions to capture content for mapping to a 3D geometric playback surface. In the example of operation, the lens 208 refracts electromagnetic radiation to the content capturing engine 210. The content capturing engine generates content that reflects differences in wavelengths of electromagnetic radiation that is refracted to the content capturing engine 210 by the lens 208. Further in the example of operation, content that is generated by the content capturing engine 210 is stored in the content datastore 212.

In the example of operation of the example system shown in FIG. 2, the 3D geometric playback surface management system 214 functions to generate a 3D geometric playback surface to which content captured by the content capturing system 204 can be mapped. Also in the example of operation, the communication engine 216 functions to receive content from the content capturing system 204. Further in the example of operation, the 3D geometric playback surface content mapping system 218 functions to map content to a 3D geometric playback surface generated by the 3D geometric playback surface management system 214 in the native format of the content. In the example of operation, the content synchronization engine 220 controls content players that play content that is mapped to a 3D geometric playback surface by the 3D geometric playback surface content mapping system 218. Further in the example of operation, the virtual sensor management system 222 functions to position and move a virtual sensor that indicates a portion of mapped to content to display to a user within a 3D geometric playback surface.

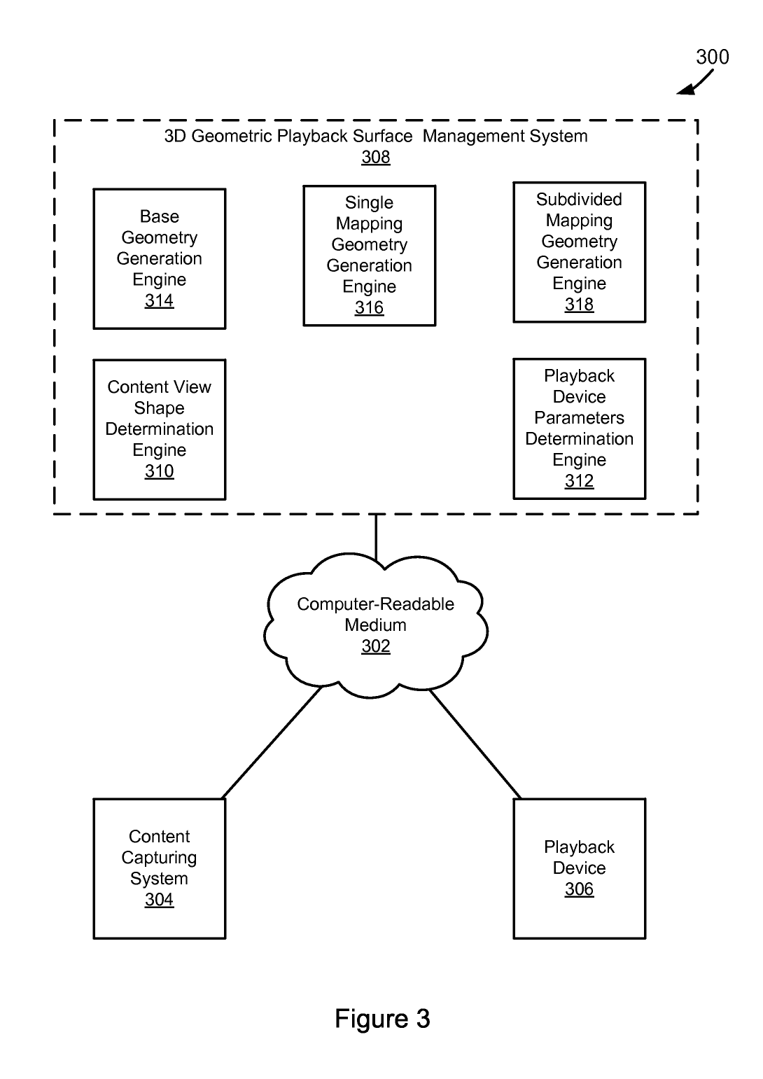

FIG. 3 depicts a diagram 300 of an example of a system for generating a 3D geometric playback surface. The example system shown in FIG. 3 includes a computer-readable medium 302, a content capturing system 304, a playback device 306, and a 3D geometric playback surface management system 308. In the example system shown in FIG. 3, the content capturing system 304, the playback device 306, and the 3D geometric playback surface management system 308 are coupled to each other through the computer-readable medium 302.

In a specific implementation, the content capturing system 304 functions according to an applicable system for capturing content, such as the content capturing systems described in this paper. The content capturing system 304 can include sensors for capturing content that includes images, both stills and video. The content capturing system 304 can also include sensors for capturing other stimuli that can be perceived by a user as if the user was in the environment in which content is captured. Specifically, the content capturing system 304 can include sensors for recording temperature, vibration, wind speed, or the like.

In a specific implementation, the playback device 306 functions according to an applicable system for displaying content that has been mapped to a 3D geometric playback surface to a user. The playback device 306 can include mechanisms through which content can be presented and/or perceived by a user of the playback device 306. For example, the playback device 306 can include a display upon which content that is images are displayed to a user of the playback device 306. In displaying content that are images to a user, the playback device 306 can display images to a user at a playback rate. In another example, the playback device 306 can include heaters and coolers for increasing or decreasing the temperature of a user or a region surrounding the user based on content that includes a temperature.

In a specific implementation, the 3D geometric playback surface management system 308 functions according to an applicable system for generating a 3D playback surface to which content can be mapped. In the example system shown in FIG. 3, the 3D geometric playback surface management system 308 includes a content view shape determination engine 310, a playback device parameters determination engine 312, a base geometry generation engine 314, a single mapping geometry generation engine 316, and a subdivided mapping geometry generation engine 318.

In a specific implementation, the content view shape determination engine 310 functions to determine a shape of a view of content. A shape of a view of content can be the shape of a view at which content is captured or should be projected to in order to view the content. Content can be contained within a plurality of source files that can be stitched together to form a shape of a view. For example, source files can be stitched together to form a 360° view. As a result, the content view shape determination engine 310 can determine that a shape of a view of content to be mapped is a cylinder centered around a user. Depending upon implementation-specific or other considerations, the content view shape determination engine 310 can determine that a content view of content is a hemisphere, a flat plane, or a cured plane.

In a specific implementation, the playback device parameters determination engine 512 functions to determine parameters of a playback device. Playback device parameters can include, by way of example, a playback rate of a playback device, resolutions of displays of a playback device, refresh rates of displays of a playback device. For example if the playback device 306 has a playback rate of 30 frames per second, then the playback device parameters determination engine 312 can determine that the playback rate of the playback device 306 is 30 frames per second. Additionally playback device parameters can include what 3D geometric playback surfaces, a playback device supports displaying content from and a number of playback surface subdivisions that a playback device support displaying content from. Depending upon implementation-specific or other considerations, the playback device parameters determination engine 312 can either instruct applicable systems or send itself, generic content to the playback device 306 in order to determine device parameters of the playback device 306. Further depending upon implementation-specific or other considerations, the playback device parameters determination engine 312 can determine playback device parameters of a playback device 306 based on an identification of the type of playback device 306 and generally available specifications of the playback device 306.

In a specific implementation, the base geometry generation engine 314 functions to generate a base geometry that is used in creating a 3D geometric playback surface to which content can be mapped. A based geometry generated by the base geometry generation engine can be either a 2D shape or a 3D shape. In one example, a base geometry generated by the base geometry generation engine 314 is an icosahedron, a 12 sided platonic solid of equilateral triangles. Depending upon implementation-specific or other considerations, the base geometry generation engine 314 can generate a base geometry based on a shape of a view of content, as determined by the content view shape determination engine 310. For example, if a shape of a view of content is a hemisphere, then the base geometry generation engine 314 can generate a base geometry that is used to create the hemispherical 3D playback surface. Further depending upon implementation-specific or other considerations, the base geometry generation engine 314 can generate a base geometry based on playback device parameters of a playback device, determined by the playback device parameters determination engine 312. For example, if the playback device supports display of content that is mapped to a hemispherical 3D geometric playback surface, then the base geometry generation engine 314 can generate a base geometry that is used to create a hemispherical 3D playback surface.

In a specific implementation, the single mapping geometry generation engine 316 functions to generate a single mapping geometry from a base geometry created by the base geometry generation engine. A single mapping geometry is the desired geometry of a 3D geometric playback surface without playback surface subdivisions. Depending upon implementation-specific or other considerations, the single mapping geometry generation engine 316 can generate a single mapping geometry based on a shape of a view of content that will be mapped to a 3D playback surface created from the single mapping geometry, as determined by the content view shape determination engine 310. Further depending upon implementation-specific or other considerations, the single mapping geometry generation engine 316 can generate a single mapping geometry based on device parameters of a playback device, as determined by the playback device parameters determination engine 312. In generating a single mapping geometry, the single mapping geometry generation engine can create an intermediary geometry by applying subdivision to a base geometry generated by the base geometry generation engine 314. For example, the single mapping geometry generation engine 316 can apply recursive linear subdivision to a base geometry to generate an intermediary geometry. Further in generating a single mapping geometry, the single mapping geometry generation engine 316 can generate the single mapping geometry from a generated geometry. In an example a single mapping geometry is created from an intermediary geometry by pushing each vertex within the intermediary geometry out from the center of the intermediary geometry out to a radius of one.

In a specific implementation, the subdivided mapping geometry generation engine 318 functions to generate a 3D playback surface from a single mapping geometry generation engine 316. The subdivided mapping geometry generation engine 318 can determine not to subdivide a single mapping geometry to include subdivided playback surfaces, in which case, the single mapping geometry generated by the single mapping geometry generation engine servers as the 3D playback surface. Alternatively, the subdivided mapping geometry generation engine 318 can determine to subdivide a single mapping geometry generated by the single mapping geometry generation engine, in which case, the single subdivided mapping geometry generation engine 318 can subdivided a single mapping geometry to create a 3D playback surface with playback surface subdivisions. Depending upon implementation-specific or other considerations, the subdivided mapping geometry generation engine 318 can determine whether to subdivide and actually subdivide a single mapping geometry generation to create a 3D geometric playback surface with playback surface subdivisions based on a shape of a view of content, as determined by the content view shape determination engine 310. Further depending upon implementation-specific or other considerations, the subdivided mapping geometry generation engine 318 can determine whether to subdivide and actually subdivide a single mapping geometry generation to create a 3D geometric playback surface with playback surface subdivisions based on playback device parameters of a playback device, as determined by the playback device parameters determination engine 312.

In an example of operation of the example system shown in FIG. 3, the content capturing system 304 captures content that is mapped to a 3D geometric playback surface. Further in the example of operation, the playback device 306 displays or allows a user to perceive content that is mapped to a 3D geometric playback surface.

In an example of operation of the example system shown in FIG. 3, the 3D geometric playback surface management system 308 generates a 3D geometric playback surface to which content captured by the content capturing system 304 can be mapped and from which the playback device 306 can display content. Also in the example of operation, the base geometry generation engine 314 generates a base geometry that is used to generate a 3D geometric playback surface. In the example of operation, the single mapping geometry generation engine 316 generates a single mapping geometry from the base geometry created by the base geometry generation engine 314. Further in the example of operation, the subdivided mapping geometry generation engine 318 determines whether to and actually dividing a single mapping geometry, generated by the single mapping geometry generation engine 316, into playback surface subdivisions, to create a 3D geometric playback surface, that can include playback surface subdivisions.

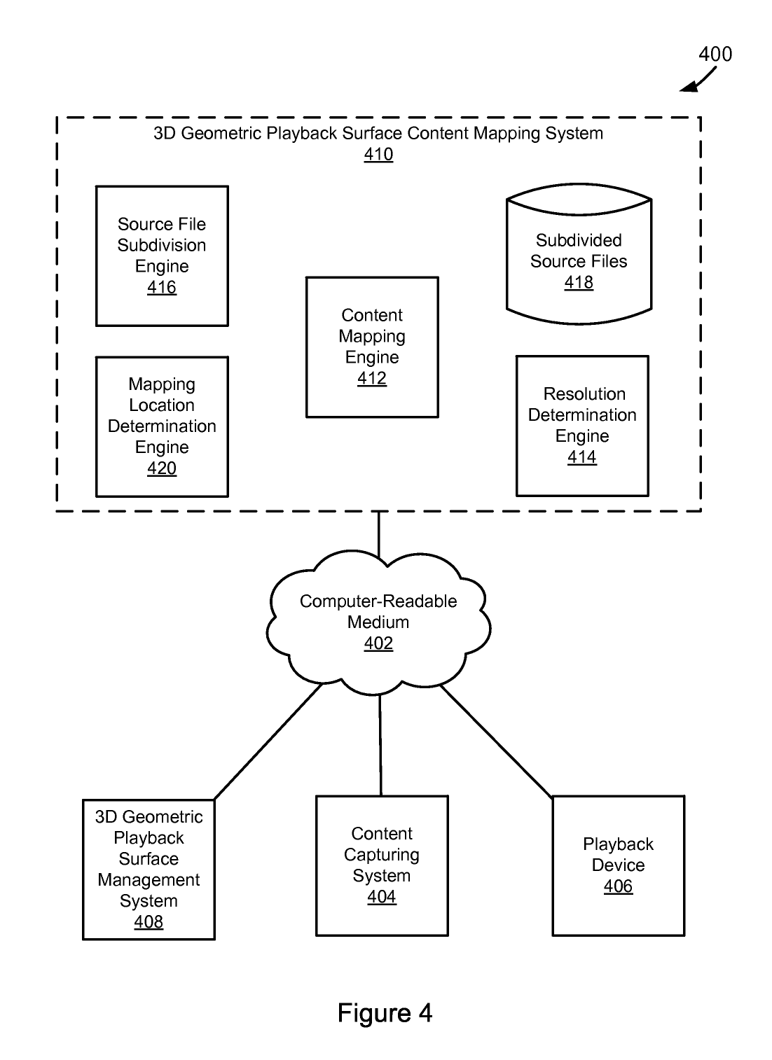

FIG. 4 depicts a diagram 400 of an example of a system for mapping content to a 3D geometric playback surface. The example system shown in FIG. 4 includes a computer-readable medium 402, a content capturing system 404, a playback device 406, a 3D geometric playback surface management system 408, and a 3D geometric playback surface mapping system. In the example system shown in FIG. 4, the content capturing system 404, the playback device 406, the 3D geometric playback surface management system 408, and the 3D geometric playback surface mapping system are coupled to each other through the computer-readable medium 402.

In a specific implementation, the content capturing system 404 functions according to an applicable system for capturing content, such as the content capturing systems described in this paper. The content capturing system 404 can include sensors for capturing content that includes images, both stills and video. The content capturing system 404 can also include sensors for capturing other stimuli that can be perceived by a user as if the user was in the environment in which content is captured. Specifically, the content capturing system 404 can include sensors for recording temperature, vibration, wind speed, or the like.

In a specific implementation, the playback device 406 functions according to an applicable system for displaying content that has been mapped to a 3D geometric playback surface to a user. Depending upon implementation-specific or other considerations, the playback device 406 can include content players that function to play content from a 3D geometric playback surface that is displayed to a user. The playback device 406 can include mechanisms through which content can be presented and/or perceived by a user of the playback device 406. For example, the playback device 406 can include a display upon which content that is images are displayed to a user of the playback device 406. In displaying content that are images to a user, the playback device 406 can display images to a user at a playback rate.

In a specific implementation, the 3D geometric playback surface management system 408 functions according to an applicable system for generating a 3D geometric playback surface, such as the 3D geometric playback surface management systems described in this paper. Depending upon implementation-specific or other considerations, the 3D geometric playback surface management system 408 functions to generate a 3D geometric playback surface based on a shape of a view of content that will be mapped to a 3D geometric playback surface. Further depending upon implementation-specific or other considerations, the 3D geometric playback surface management system 408 functions to generate a 3D geometric playback surface based on playback device parameters of a playback device that content mapped to the 3D geometric playback surface will be displayed on.

In a specific implementation, the 3D geometric playback surface content mapping system 410 functions according to an applicable system for mapping content to a 3D geometric playback surface, such as the 3D geometric playback surfaces described in this paper. In the example system shown in FIG. 4, the 3D geometric playback surface content mapping system 410 includes content mapping engine 412, a resolution determination engine 414, a source file subdivision engine 416, a subdivided source files datastore 418, and a mapping location determination engine 420.

In a specific implementation, the content mapping engine 412 functions to map content captured by the content capturing system 404 to a 3D geometric playback surface generated by the 3D geometric playback surface management system 408. The content mapping engine 412 can map content to a 3D geometric playback surface in the native format in which the content was captured and created. For example, if content is captured as asf data, the content mapping engine 412 can map the content to a 3D geometric playback surface as asf data. Depending upon implementation-specific or other considerations, the content mapping engine 412 can map content to a 3D geometric playback surface as the content is captured and generated by the content capturing system 404. Further depending upon-implementation specific or other considerations, the content mapping engine 412 can map content to specific playback surface subdivisions in a 3D geometric playback surface. In an example, content that is mapped to specific playback surface subdivision in a 3D geometric playback surface can be uniquely associated with the specific playback surface subdivisions to which the content is mapped.

In a specific implementation, the resolution determination engine 414 determines a resolution of content that is captured by the content capturing system 404. Further in the specific implementation, the resolution determination engine 414 determines a highest supported resolution of content that can be displayed on a display included in the playback device 406. The resolution determination engine 414 can determine the highest supported resolution of content that can be displayed on a display included in the playback device 406 from playback device parameters of the playback device 406. Still further in the specific implementation, the resolution determination engine 414 can compare a determined highest supported resolution of content that can be displayed on a display included in the playback device 406 with a determined resolution of content captured by the content capturing system 404. If the resolution determination engine 414 determines that resolution of content captured by the content capturing system is higher than the highest resolution of content that can be displayed on a display included in the playback device 406, then the resolution determination engine can generate a subdivision command that indicates to subdivided a source file that includes the content captured and generated by the content capturing system 404.

In a specific implementation, the source file subdivision engine 416 functions to subdivided a source file that includes content captured and generated by the content capturing system 404. The source file subdivision engine 416 can subdivide a source file based on a subdivision command generated by the resolution determination engine 414. Specifically, if the resolution determination engine 414 determines that a resolution of content is too high to be displayed on a display included as part of the playback device 406, then the source file subdivision engine 416 can subdivide a source file that includes the content into a plurality of subdivided source files that each have a lower resolution than the source file from which they were subdivided. The source file subdivision engine 416 can divide up content included in a source file into content included in subdivided source files that are in the same native format as the content included in the source file from which the subdivided source files is crated. For example, if a source file includes captured content as asf data, then the source file subdivision engine 416 can divide the content into subdivided source files that include portions of the content as asf data. Subdivided source files generated by the source file subdivision engine can be stored in the subdivided source files datastore 418. In various implementations, the content mapping engine 412 can map a plurality of subdivided source files stored in the subdivided source files datastore 418 to a 3D geometric playback surface generated by the 3D geometric playback surface management system 408.

In a specific implementation, the mapping location determination engine 420 functions to determine a location or a portion of a 3D geometric playback surface to map content to that is generated and captured by the content capturing system 404. Depending upon implementation-specific or other considerations, the mapping location determination engine 420 determines and associates content, a source file that contains content, or a subdivided source file, to a specific playback surface subdivision within a 3D playback surface to map the content. The mapping location determination engine 420 can determine a location or a portion of a 3D geometric playback surface to map content to based on a position of a content capturing system 404 when capturing and/or generating the content. For example, if the content capturing system 404 was pointed to the left from a central reference capture point when capturing content, then the mapping location determination engine can determine that the content should be mapped to a location or a portion of a 3D geometric playback surface that is to the left of a central point in the 3D geometric playback surface that corresponds to the central reference capture point.

In a specific implementation, the content mapping engine 412 maps content to a location or portion of a 3D geometric playback surface based on a position or location to map the content to, as is determined by the mapping location determination engine 420. For example, if the mapping location determination engine 420 determines to map content to a portion or a location to the left of a central a central position in the 3D geometric playback surface, then the content mapping engine 412 can map the content to the portion or location to the left of the central position in the 3D geometric playback surface. Depending upon implementation-specific or other considerations, the content mapping engine 412 can map content to a playback surface subdivision in a 3D geometric playback surface that the mapping location determination engine 420 determines the content should be mapped.

In a specific implementation, the content mapping engine 412 maps content to a 3D geometric playback surface at a render rate independently of a playback rate of content players that play content mapped to the 3D geometric playback surface. The content mapping engine 412 can map content to a 3D geometric playback surface at a rate that is greater than a playback rate of content players that play content mapped to the 3D geometric playback surface. In one example, the content mapping engine 412 can map content to a 3D geometric playback surface at a render rate of up to 60 frames per second, even if the content players play content mapped to the 3D geometric playback surface at a rate of 24 to 30 frames per second.

In an example of operation of the example system shown in FIG. 4, the content capturing system 404 functions to capture and generate content for mapping to a 3D geometric playback surface. Further in the example of operation, the playback device 406 functions to display content that is played from a 3D geometric playback surface to which the content is mapped. Also in the example of operation, the 3D geometric playback surface management system 408 generates a 3D geometric playback surface to which content can be mapped.

In the example of operation of the example system shown in FIG. 4, the resolution determination engine 414 functions to determine if a resolution of content that will be mapped to a 3D geometric playback surface is too high to be displayed on a display included as part of a playback device 406. Further in the example of operation, if it is determined that the resolution of content is too high to be displayed in a display of the playback device 406, then the source file subdivision engine 416 functions to generate a plurality of subdivided source files from the a source file that includes the content. The plurality of subdivides source files can be stored in the subdivided source files datastore 418. Also in the example of operation, the mapping location determination engine 420 functions to determine a portion of a location within a 3D geometric playback surface to map the plurality of subdivided source files. In the example of operation, the content mapping engine 412 maps content included in the subdivided source files to appropriate portions or locations on a 3D geometric playback surface, as determined by the mapping location determination engine 420.

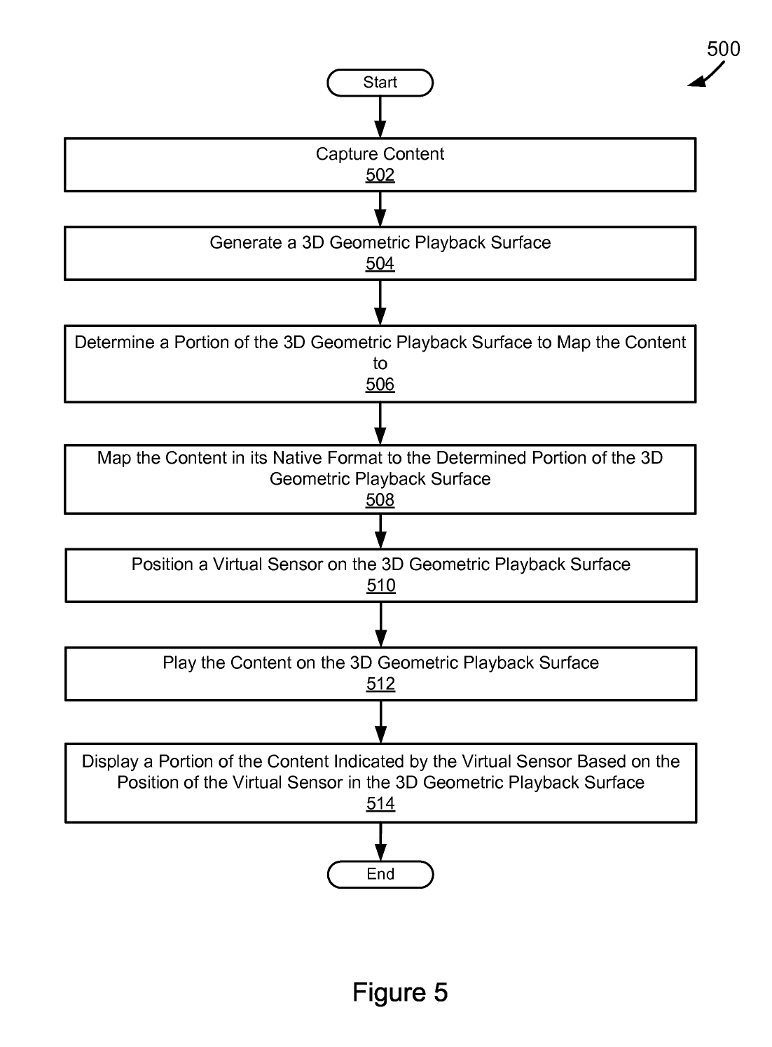

FIG. 5 depicts a flowchart 500 of an example of a method for mapping content to a 3D geometric playback surface. The flowchart 500 begins at module 502 where content is captured and generated. The content can be captured by a content capturing system. Content captured at module 502 can include images, both still and video, that can be displayed to a user of a playback device.

The flowchart 500 continues to module 504, where a 3D geometric playback surface is generated. Depending upon implementation-specific or other considerations, a 3D geometric playback surface can be generated based on a shape of a view of content captured at module 502. Further depending upon implementation-specific or other considerations, a 3D geometric playback surface can be generated based on playback device parameters of a playback device through which content will be displayed to a user.

The flowchart 500 continues to module 506, where a portion of a 3D geometric playback surface to map content to is determined. A portion of a 3D geometric playback surface can include a point in a 3D geometric playback surface that is at the center of the portion the 3D geometric playback surface. Depending-upon implementation specific or other considerations, a portion of a 3D geometric playback surface to map content to is determined based on a position of a content capturing system, when the content capturing system captured the content.

The flowchart 500 continues to module 508 where content is mapped in its native format to a 3D geometric playback surface. For example, if content is captured and generated as asf data, then it can be mapped to a 3D geometric playback surface directly as asf data. At module 508, content is mapped to a portion of a 3D geometric playback surface based on a determined portion of the 3D geometric playback surface to map the content to, as is determined at module 506.

The flowchart 500 continues to module 510 where a virtual sensor is placed and positioned on a 3D geometric playback surface. A virtual sensor placed and positioned on a 3D geometric playback surface can indicate a portion of content mapped to the 3D geometric playback surface to display to a user of a playback device. A virtual sensor can be moved within a 3D geometric playback surface based on received input as a user is presented with displayed content. For example, input can include that a user has tilted their head to the left and a virtual sensor can be moved to the left in the 3D geometric playback surface to cause new content to be displayed to the user.

The flowchart continues to module 512, where content mapped to the 3D geometric playback surface is played. Depending upon implementation-specific or other considerations content from a plurality of source files or subdivided source files that is mapped to the 3D geometric playback surface is played simultaneously, thereby aggregating the content. Content mapped to the 3D geometric playback surface are played by content players that can be implemented as part of or separate from a playback device through which content will be displayed to a user.

The flowchart continues to module 514, where a portion of content indicated by a virtual sensor is played based on a position of the virtual sensor in a 3D geometric playback surface. For example, all content within a 1000 by 1000 pixel window formed about a virtual sensor can be displayed to a user. A portion of content indicated by a virtual sensor can be displayed to a user through a playback device that includes a display.

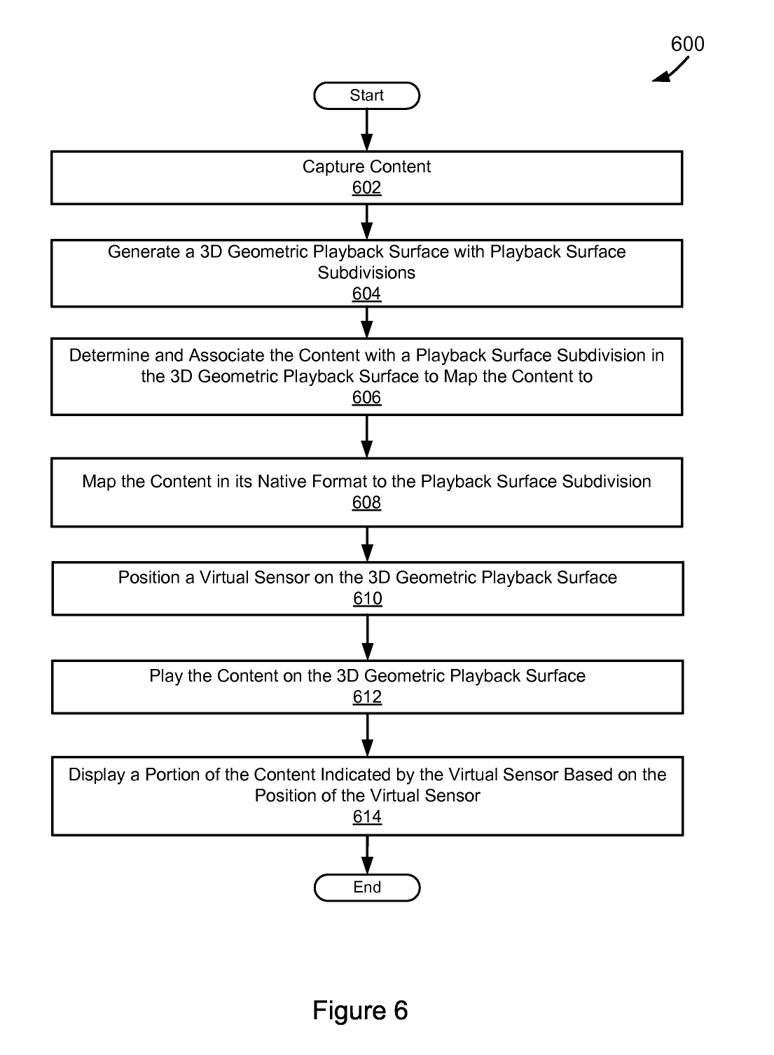

FIG. 6 depicts a flowchart 600 of an example of a method for mapping content to a 3D geometric playback surface with playback surface subdivisions. The flowchart 600 begins at module 602 where content is captured and generated. The content can be captured by a content capturing system. Content captured at module 602 can include images, both still and video, that can be displayed to a user of a playback device.

The flowchart 600 continues to module 604, where a 3D geometric playback surface with playback surface subdivisions is generated. Depending upon implementation-specific or other considerations, a 3D geometric playback surface with playback surface subdivisions can be generated based on a shape of a view of content captured at module 602. Further depending upon implementation-specific or other considerations, a 3D geometric playback surface with playback surface subdivisions can be generated based on playback device parameters of a playback device through which content is displayed to a user.

The flowchart continues to module 606, where a playback surface subdivision in a 3D geometric playback surface to map content to is determined. Further at module 606, a playback surface subdivision in a 3D geometric playback surface to map content to is uniquely associated with the content. Depending upon implementation-specific or other considerations, in uniquely associating a playback surface subdivision with content, the content is only mapped to and played from the playback surface subdivision in a 3D geometric playback surface that which it is uniquely associated.

The flowchart continues to module 608, where content is mapped in its native format to a playback surface subdivision of a 3D geometric playback surface. For example, if content is captured and generated as asf data, then it can be mapped to a playback surface subdivision of a 3D geometric playback surface directly as asf data. At module 608, content is mapped to a playback surface subdivision of a 3D geometric playback surface based on a determined playback surface subdivision of the 3D geometric playback surface to map the content to, as is determined at module 606.

The flowchart 600 continues to module 610 where a virtual sensor is placed and positioned on a 3D geometric playback surface that includes playback surface subdivisions. A virtual sensor placed and positioned on a 3D geometric playback surface can indicate a portion of content mapped to the 3D geometric playback surface to display to a user of a playback device. Further, a virtual sensor placed and positioned on a 3D geometric playback surface can indicate to display content mapped to a specific one or a plurality of geometric playback surface subdivisions of the 3D geometric playback surface. A virtual sensor can be moved within a 3D geometric playback surface based on received input as a user is presented with displayed content. For example, input can include that a user has tilted their head to the left and a virtual sensor can be moved to the left in the 3D geometric playback surface to cause new content to be displayed to the user.

The flowchart continues to module 612, where content mapped to the 3D geometric playback surface with playback surface subdivisions is played. Depending upon implementation-specific or other considerations content from a plurality of source files or subdivided source files that is mapped to the 3D geometric playback surface is played simultaneously, thereby aggregating the content. Content mapped to the 3D geometric playback surface are played by content players that can be implemented as part of or separate from a playback device through which content is displayed to a user.

The flowchart continues to module 614, where a portion of content indicated by a virtual sensor is played based on a position of the virtual sensor in a 3D geometric playback surface with playback surface subdivisions. For example, all content within a 1000 by 1000 pixel window formed about a virtual sensor can be displayed to a user. A portion of content indicated by a virtual sensor can be displayed to a user through a playback device that includes a display.

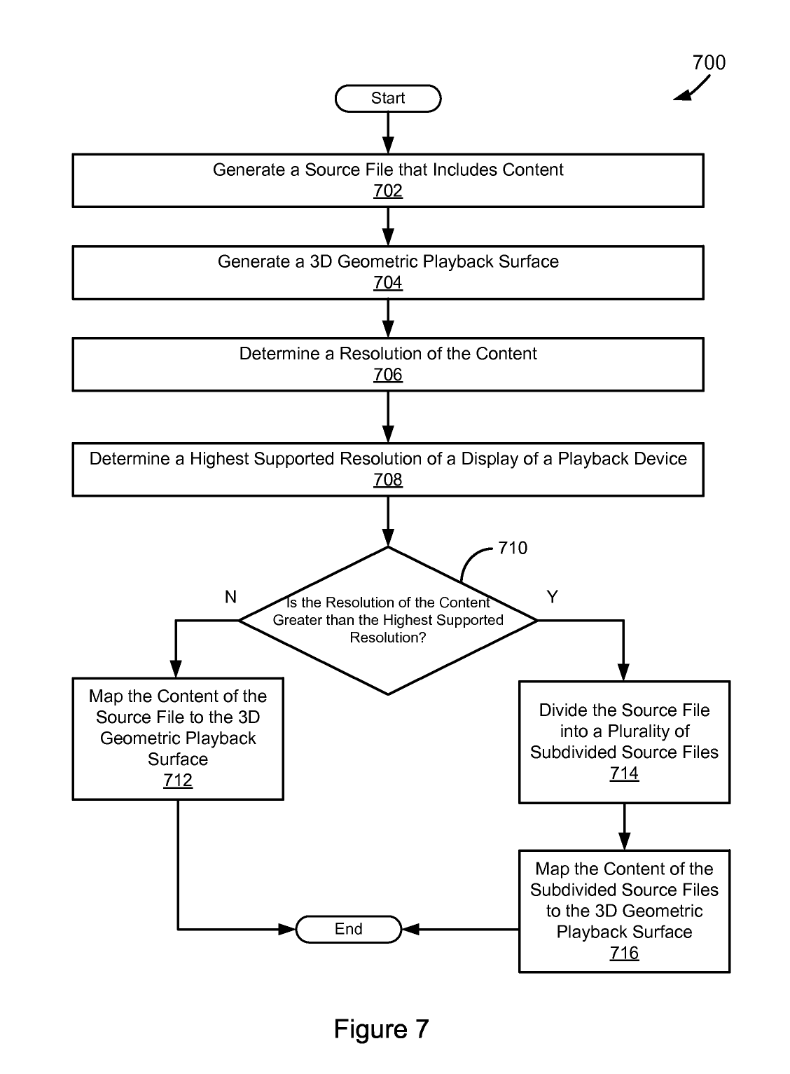

FIG. 7 depicts a flowchart 700 of an example of a method for dividing a source file that contains content based on resolution and mapping the content to a 3D geometric playback surface. The flowchart 700 begins at module 702 where a source file that includes captured content is generated. Content included in the source file can include images, both still and video.

The flowchart 700 continues to module 704, where a 3D geometric playback surface is generated. Depending upon implementation-specific or other considerations, a 3D geometric playback surface can be generated based on a shape of a view of content included in the source file generated at module 702. Further depending upon implementation-specific or other considerations, a 3D geometric playback surface can be generated based on playback device parameters of a playback device through which content included in a source file generated at module 702, will be displayed to a user.

The flowchart 700 continues to module 706, where a resolution of content included in the source file generated at module 702 is determined. A resolution of content included in a source file can be determined by an applicable system for determining resolution, such as the resolution determination engine described in this paper.

The flowchart 700 continues to module 708, where a highest supported resolution of a display included in a playback device on which content included in a source file is displayed is determined. A highest supported resolution of a display included in a playback device can be determined by an applicable system for determining a highest supported resolution of a display, such as the resolution determination engine described in this paper.

The flowchart 700 continues to decision point 710, where it is determined whether a resolution of content included in a source file is greater than a highest supported resolution of a display in a playback device on which content will be displayed. If it is determined at decision point 710 that resolution of content included in a source file is less than a highest supported resolution of a display in a playback device, then the flowchart 700 continues to module 712, where content included in a source file generated at module 702, is mapped to a portion of the 3D geometric playback surface. At module 712, content can be mapped to a 3D geometric playback surface in the native format of the content included in a source file. Alternatively if it is determined at decision point 710 that the resolution of content included in a source file is greater than a highest support resolution of a display in a playback device, then the flowchart 700 continues to module 714.

At module 714, the flowchart includes dividing a source file generated at module 702 into a plurality of subdivided source files. A source file can be divided into a plurality of subdivided source files in the native format of the source file from which the plurality of source files were divided. A source file can be divided into a plurality of subdivided source files, such that the content in the plurality of subdivided source files has a lower resolution than content in the source file from which the plurality of subdivided source files were divided.

The flowchart continues to module 716, where content included in a plurality of subdivided source files is mapped to portions of a 3D geometric playback surface. Content included in a plurality of subdivided source files can be mapped to a 3D geometric playback surface in the native format of the content in the plurality of subdivided source files. Content included in each subdivided source file can be mapped to a different portion of a 3D geometric playback surface.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
generating a source file including content in a native format;
generating a 3D geometric playback surface;
determining a portion of the 3D geometric playback surface to map the content to;
mapping the content in the native format to the portion of the 3D geometric playback surface;
playing the content from the 3D geometric playback surface.

2. The method of claim 1, further comprising:
determining a resolution of the content;
determining a highest supported resolution of a playback device to display the content;
if it is determined that the resolution of the content is greater than the highest supported resolution of the playback device:
dividing the source file into a plurality of subdivided source files;
determining a plurality of portions of the 3D geometric playback surface to map content included in the subdivided source files to;
mapping the content included in the subdivided source files to the plurality of portions of the 3D geometric playback surface.

3. The method of claim 1, wherein the 3D geometric playback surface is generated based on a shape of a view of the content.

4. The method of claim 1, wherein the 3D geometric playback surface is generated based on playback parameters of a playback device to display the content.

5. The method of claim 1, wherein the content is mapped to the 3D geometric playback surface at a render rate and the content is played from the 3D geometric playback surface at a playback rate that is less than the render rate.

6. The method of claim 1, further comprising:
positioning a virtual sensor on the 3D geometric playback surface that indicates a portion of the content to display;
displaying the portion of content based on a position of the virtual sensor.

7. The method of claim 6, further comprising, moving the virtual sensor on the 3D geometric playback surface based on input received from a user, the input including a direction of a movement of the user.

8. The method of claim 1, further comprising:
associating the content to a playback surface subdivision of the 3D geometric playback surface;
mapping the content in the native format to the playback surface subdivision of the 3D geometric playback surface.

9. The method of claim 1, wherein the portion of the 3D geometric playback surface to map the content to is determined based on a position of a content capturing system when the content capturing system captured the content.

10. The method of claim 1, wherein generating a 3D geometric playback surface further comprises:
generating a base geometry;
generating an intermediary geometry from the base geometry using subdivision;
generating a single mapping geometry from the intermediary geometry;
subdividing the single mapping geometry into a plurality of geometric playback surfaces.

11. A system comprising:
a content capturing system configured to generate a source file including content in a native format;
a 3D geometric playback surface management engine configured to generate a 3D geometric playback surface;
a mapping location determination engine configured to determine a portion of the 3D geometric playback surface to map the content to;
a content mapping engine configured to map the content in the native format to the portion of the 3D geometric playback surface;
a content player configured to play the content from the 3D geometric playback surface.

12. The system of claim 11 further comprising:
a resolution determination engine configured to:
determine a resolution of the content;
determine a highest supported resolution of a playback device to display the content;
a source file subdivision engine configured to divide the source file into a plurality of subdivided source files if it is determined that the resolution of the content is greater than the highest supported resolution of the playback device;
the mapping location determination engine further configured to determine a plurality of portions of the 3D geometric playback surface to map content included in the subdivided source files to;
the content mapping engine further configured to map the content included in the subdivided source files to the plurality of portions of the 3D geometric playback surface.

13. The system of claim 11, wherein the 3D geometric playback surface management system is further configured to:
determine a shape of a view of the content;
generate the 3D geometric playback surface based on the shape of the view of the content.

14. The system of claim 11, wherein the 3D geometric playback surface management system is further configured to:
determine playback device parameters of a playback device to display the content;
generate the 3D geometric playback surface based on the playback device parameters of the playback device to display the content.

15. The system of claim 11, wherein content mapping engine maps the content to the 3D geometric playback surface at a render rate and the content player plays the content from the 3D geometric playback surface at a playback rate that is less than the render rate.

16. The system of claim 11, further comprising:
a virtual sensor management system configured to position a virtual sensor on the 3D geometric playback surface that indicates a portion of the content to display;
a playback device configured to display the portion of content based on a position of the virtual sensor on the 3D geometric playback surface.

17. The system of claim 16, wherein the virtual sensor management system is configured to move the virtual sensor on the 3D geometric playback surface based on input received from a user, the input including a direction of a movement of the user.

18. The system of claim 11, wherein:
the mapping location determination engine is further configured to associated the content to a playback surface subdivision of the 3D geometric playback surface;
the content mapping engine is further configured to map the content in the native format to the playback surface subdivision of the 3D geometric playback surface.

19. The system of claim 11, wherein the mapping location determination engine is further configured to determine a portion of the 3D geometric playback surface to map the content to is determined based on a position of a content capturing system when the content capturing system captured the content.

20. A system comprising:
means for generating a source file including content in a native format;
means for generating a 3D geometric playback surface;
means for determining a portion of the 3D geometric playback surface to map the content to;
means for mapping the content in the native format to the portion of the 3D geometric playback surface;
means for playing the content from the 3D geometric playback surface.
